(19) United States
(12) Patent Application Publication
(10) Pub. No.: US 2015/0212815 A1
(43) Pub. Date: Jul. 30, 2015

(54) METHODS AND SYSTEMS FOR MAINTENANCE AND CONTROL OF APPLICATIONS FOR PERFORMANCE TUNING

(71) Applicant: Nvidia Corporation, Santa Clara, CA (US)

(72) Inventor: Neha Joshi, Pune (IN)

(73) Assignee: Nvidia Corporation, Santa Clara, CA (US)

(21) Appl. No.: 14/163,916

(22) Filed: Jan. 24, 2014

(51) Int. Cl. G06F 9/44

(52) U.S. Cl. CPC G06F 8/71

(57) ABSTRACT

Methods and systems for maintenance and control of multiple versions of an application are disclosed. The method includes creating a first version of the application comprising computer-executable instructions and executing the first version of the application. The first version of the application and related performance metrics are stored in a memory. The method includes creating at least one modified version of the application by making changes to the computer-executable instructions and executing the modified version of the application. The modified version of the application and related performance metrics are stored in the memory. The method includes comparing the performance of the modified version of the application to the performance of the first version of the application by comparing their respective performance metrics and deleting the lower performing version.

### TECHNICAL FIELD

The present disclosure is directed, in general, to data processing systems and methods and, more particularly, to methods and systems for maintenance and control of applications for performance tuning.

### BACKGROUND

Parallel computing platforms have increased computing performance by harnessing the power of graphics processing units (GPUs). Using high-level programming languages, GPU-accelerated applications run sequential components of their workload on central processing units (CPUs), which are optimized for single threaded performance, while running parallel processing on GPUs.

For example, CUDA™, which is a parallel computing platform and programming model developed by NVIDIA Incorporated of Santa Clara, Calif., increases computing performance by running sequential processing code on a CPU while running parallel processing code on a GPU. CUDA is widely deployed through thousands of applications and is supported by an installed base of millions of CUDA-enabled GPUs in notebooks, workstations, compute clusters and supercomputers. With millions of CUDA-enabled GPUs sold to date, software developers, scientists and researchers are finding broad-ranging use for GPU computing with CUDA. A software developer may harness the performance of a GPU by writing a code using a CUDA Toolkit, which provides a comprehensive development environment for C and C++ developers.

During the tuning phase of a GPU-enabled parallel computing program, software developers often create multiple versions of a code in order to compare performance metrics of the different versions. Thus, it is necessary to maintain the different versions of the code while the performance metrics of different versions are being compared and evaluated.

Consider, for example, that a software developer has created a new version of a code by making changes to a previous version. The software developer may compare the performance of the most recent version of the code to the performance of the previous version of the code. The comparison may reveal that the most recent version of the code degrades the performance compared to the previous version. In such a scenario, the software developer may then identify the changes made to the most recent version of the code and manually revert the changes back to the previous version that provided superior performance. In other instances, changes made to a code may cause functional issues that make it difficult for a developer to continue without reverting back to the previous version. Accordingly, methods and systems which enable efficient maintenance and control of multiple versions of applications for performance tuning are desired.

### SUMMARY

Various disclosed embodiments are directed to methods and systems for maintenance and control of multiple versions of an application and related performance metrics. The method includes creating a first version of the application comprising computer executable instructions and executing the first version of the application. The first version of the application and related performance metrics are stored in a memory.

The method includes creating at least one modified version of the application by making changes to the computer executable instructions and executing the modified version of the application. The modified version of the application and related performance metrics are stored in the memory.

The method includes comparing the performance of the modified version of the application to the performance of the first version of the application by comparing their respective performance metrics. The method includes determining if the performance of the modified version of the application is superior or inferior to the performance of the first version of the application. The method includes deleting the first version of the application from the memory if the performance of the modified version of the application is superior to the performance of the first version of the application. The method includes deleting the modified version of the application from the memory if the performance of the modified version of the application is inferior to the performance of the first version of the application.

According to various disclosed embodiments, the method includes creating a plurality of modified versions of the application by making changes to the computer executable instructions and executing the modified versions of the application. The modified versions of the application and respective performance metrics are stored in the memory. The method includes comparing the performance of the stored applications by comparing their respective performance metrics. The method includes deleting at least one stored application from the memory based on the comparison.

According to various disclosed embodiments, the method includes determining if a maximum allowable number of versions that can be saved in the memory is exceeded. The method includes deleting one or more lower performing versions from the memory if the maximum allowable number of versions that can be saved in the memory is exceeded.

The method includes determining if the performance of the most recent version of the application is equal to or greater than a threshold performance. The method includes storing the most recent version of the application in the memory and deleting the previous versions of the application from the memory if the performance of the most recent version of the application is equal to or greater than a threshold performance.

According to various disclosed embodiments, a data processing system for maintenance and control of multiple versions of an application includes at least one processor and a memory connected to the processor. The data processing system is configured to: create a first version of the application comprising computer executable instructions; execute, by the processor, the first version of the application; store the first version of the application and related performance metrics in a memory; create at least one modified version of the application by making changes to the program code; execute, by the processor, the modified version of the application; and store the modified version of the application and related performance metrics in the memory.

The data processing system is configured to: compare, by the processor, the performance of the modified version of the application to the performance of the previous version of the application by comparing their respective performance metrics; and determine, by the processor, if the performance of the modified version of the application is superior or inferior to the performance of the previous version of the application.

The data processing system is configured to: delete the previous version of the application from the memory if the performance of the modified version of the application is superior to the performance of the first version of the application. The data processing system is configured to: delete the modified version of the application from the memory if the performance of the modified version of the application is inferior to the performance of the previous version of the application.

According to various disclosed embodiments, a non-transitory computer-readable medium encoded with computer-executable instructions maintain and control multiple versions of an application and related performance metrics. The computer-executable instructions when executed cause at least one data processing system to: create a first version of the application comprising the computer executable instructions; execute the first version of the application; store the first version of the application and related performance metrics in a memory; create at least one modified version of the application by making changes to the computer executable instructions; execute the modified version of the application; and store the modified version of the application and related performance metrics in the memory.

The computer-executable instructions when executed cause at least one data processing system to: compare the performance of the modified version of the application to the performance of the previous version of the application by comparing their respective performance metrics; and determine if the performance of the modified version of the application is superior or inferior to the performance of the previous version of the application. The computer-executable instructions when executed cause at least one data processing system to delete the previous version of the application from the memory if the performance of the modified version of the application is superior to the performance of the previous version of the application.

The computer-executable instructions when executed cause at least one data processing system to delete the modified version of the application from the memory if the performance of the modified version of the application is inferior to the performance of the previous version of the application.

### BRIEF DESCRIPTION

Reference is now made to the following descriptions taken in conjunction with the accompanying drawings, in which:

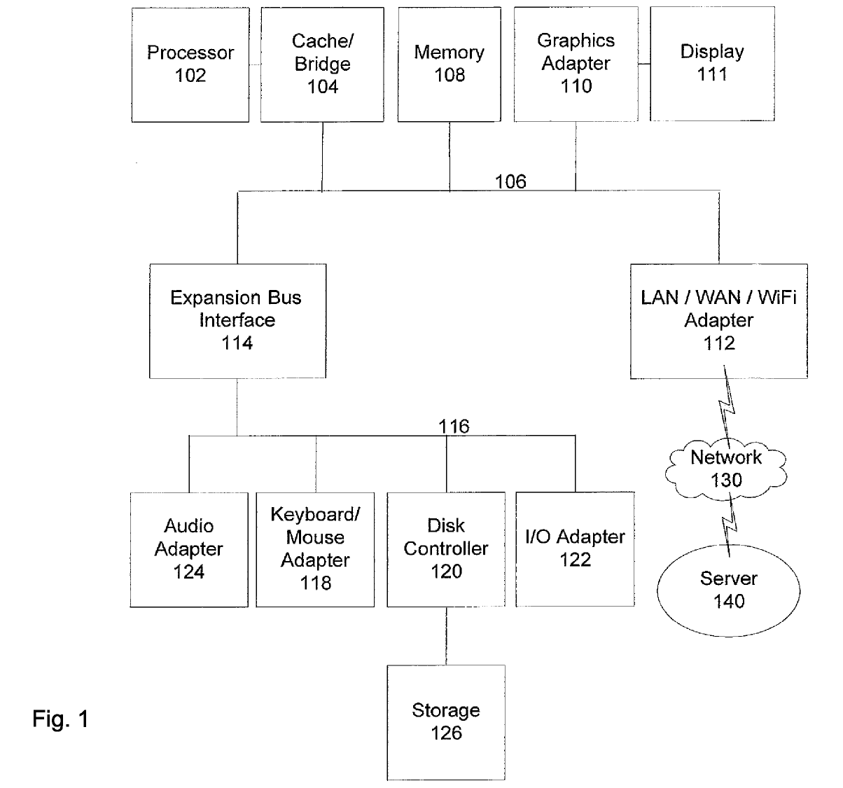

FIG. 1 illustrates a block diagram of a data processing system according to various disclosed embodiments;

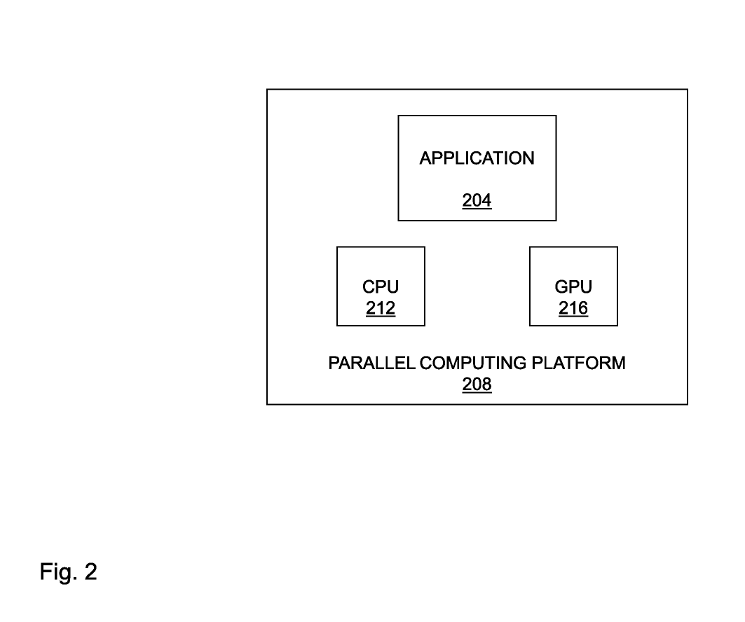

FIG. 2 illustrates a block diagram of an application according to various disclosed embodiments; and

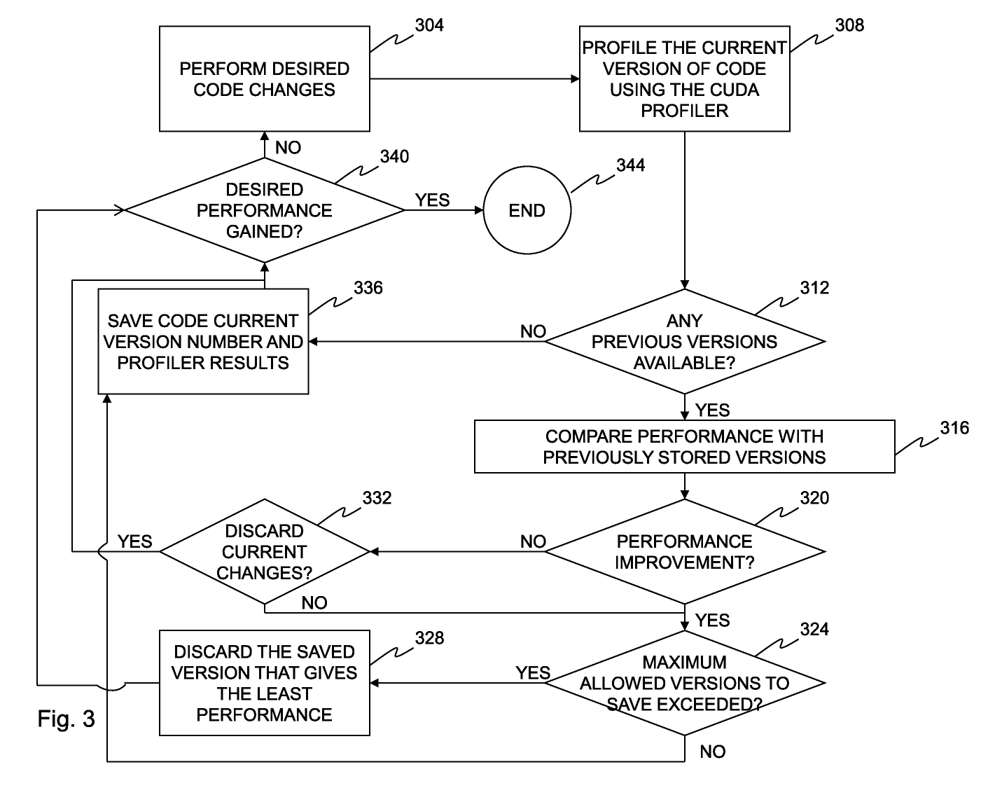

FIG. 3 is a flowchart of a process according to various disclosed embodiments.

### DETAILED DESCRIPTION

FIGS. 1-3, discussed below, and the various embodiments used to describe the principles of the present disclosure in this disclosure are by way of illustration only and should not be construed in any way to limit the scope of the disclosure. Those skilled in the art will recognize that the principles of the disclosure may be implemented in any suitably arranged device or a system. The numerous innovative teachings of the present disclosure will be described with reference to exemplary non-limiting embodiments

Various disclosed embodiments provide methods and systems for maintenance and control of multiple versions of an application during performance tuning. In particular, the disclosed embodiments provide methods and systems for maintenance and control of multiple versions of an application and associated performance metrics by running the multiple versions of the application using a tool such as, for example, a profiler, during performance tuning. The disclosed embodiments allow a user to make changes to computer executable instructions, compare the performance metrics of the various versions and thus fine tune the application.

According to various disclosed embodiments, sequential processing code is executed on CPUs while parallel processing code is executed on GPUs. The disclosed embodiments enable software developers to maintain and control different versions of a computer program during performance tuning using a profiler, such as, for example, the CUDA™ profiler or other parallel computing platforms.

According to various disclosed embodiments, changes made to previous versions during performance tuning are preserved, and thus are not lost. According to disclosed embodiments, the profiler compares performance of the most recent version of the code to the performance of previous versions of the code. Based on the comparison, suggestion is provided regarding which version to maintain. The comparison may be based on one or more metrics such as, for example, GPU Kernel time.

According to various disclosed embodiments, methods and systems for versioning control of an application may be implemented as an application integrated in a parallel computing development platform. For example, the disclosed embodiments may be implemented as an application which is integrated in NVIDIA Nsight Eclipse or NVIDIA Nsight Studio, which are widely used development platforms for parallel computing. When implemented as an integrated application in NVIDIA Nsight Eclipse or NVIDIA Nsight Studio platforms, a software developer may utilize debugging and profiling tools available in the platforms to optimize the performance of CPUs and GPUs.

FIG. 1 depicts a block diagram of data processing system 100 in which an embodiment can be implemented, for example, as a system particularly configured by software, hardware or firmware to perform the processes as described herein, and in particular as each one of a plurality of interconnected and communicating systems as described herein. Data processing system 100 may be implemented as an application (e.g., software module) configured to maintain and control multiple versions of a tuning application. The application may be integrated into a parallel computing platform to enable software developers to optimize the performance of CPUs and GPUs. By way of example, the application may be integrated in the NVIDIA Nsight Eclipse edition or the NVIDIA Nsight Visual Studio edition, which are widely used development platforms for parallel computing. As discussed before, when implemented as an integrated application in the NVIDIA Nsight Eclipse edition or the NVIDIA Nsight Visual Studio edition, a software developer may utilize debugging and profiling tools of the platforms to optimize the performance of CPUs and GPUs.

Referring to FIG. 1, the data processing system depicted includes processor 102 connected to level two cache/bridge 104, which is connected in turn to local system bus 106. Local system bus 106 may be, for example, a peripheral component interconnect (PCI) architecture bus. Also connected to local system bus in the depicted example are main memory 108 and graphics adapter 110. Graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

Data processing system 100 in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100. Data processing system 100 may be configured as a workstation, and a plurality of similar workstations may be linked via a communication network to form a distributed system in accordance with embodiments of the disclosure.

FIG. 2 illustrates an exemplary block diagram of application 204 according to various disclosed embodiments. Application 204 comprises computer executable instructions for maintaining and controlling multiple versions of an application during performance tuning. Application 204 may be integrated into parallel computing platform 208 to enable software developers to optimize the performance of CPU 212 and GPU 216. By way of example, parallel computing platform 208 may be the NVIDIA Nsight Eclipse or the NVIDIA Nsight Studio, which are widely used development platforms.

FIG. 3 is a flowchart of a process according to various disclosed embodiments. Such a process can be performed, for example, by application 204 configured to maintain and control multiple versions of an application during performance tuning, as described above, but the process can be performed by any apparatus configured to perform a process as described.

Consider, for example, that a software developer has created a code (i.e., computer-executable instructions) and would like to maximize its performance by making changes to the code using the CUDA profiler or any other profiler. In block 304, the software developer may make desired changes to the code. In block 308, the most recent or current version of the code is executed or profiled using the CUDA profiler. By executing or running the code, the software developer can evaluate the performance of the application. The most recent version of the code and related execution results may be stored in a memory.

Next, in block 312, a determination is made whether there are previous versions of the code stored in the memory. If previous versions of the code are available, the process moves to block 316 where the performance of the most recent version of the code is compared to the performance of the previous versions of the code. According to various disclosed embodiments, the performance of the various versions of the code may be compared based on their respective GPU Kernel times. It will, however, be appreciated that other metrics may be used to compare the performance of various versions of the code.

Based on the comparison, a determination is made in block 320 whether a performance improvement has been gained from the most recent version of the code. If a performance improvement has been gained from the most recent version of the code, the process moves to block 324 where a determination is made whether a maximum allowable number of versions that can be saved, has been exceeded. Depending on the size of memory space allocated by the system, a software developer may save a maximum allowable number of versions. If the maximum allowable number of versions that can be saved has been exceeded, the process moves to block 328 where the version providing the lowest performance is identified and the lowest performing version is deleted. Alternatively, a plurality of lower performing versions of the code may be deleted from the memory in order to free up memory space.

Referring back to block 320, if a performance improvement has not been gained from the most recent version of the code, the process moves to block 332 where a decision is made whether the most recent version of the code should be deleted. Consider, for example, that the most recent version of the code degrades the performance of the application compared to the performance of the previous versions. In such a case, in block 332 a decision is made whether to delete the most recent version of the code. If a decision is made not to delete the most recent version of the code, the process moves to block 324. Otherwise, the process moves to block 340.

Referring again to block 324, if a maximum allowable number of versions that can be saved have not been exceeded, the process moves to block 336 where the most recent version of the code is saved in the memory. Also, in block 336, the profiler results of the most recent version of the code are saved.

Next, the process moves to block 340 where a decision is made whether a desired performance by the most recent version of the code has been gained. For example, the performance of the code may be compared to a threshold performance level. If the performance of the code is equal to or greater than the threshold performance level, the desired performance has been gained, and the process moves to block 344 where the process is concluded. If the desired performance has not been gained, the process returns to block 304 where the software developer may make further changes to the code.

According to some disclosed embodiments, a non-transitory computer-readable medium encoded with computer-executable instructions maintains and controls multiple versions of an application. The computer-executable instructions when executed cause at least one data processing system to: create a first version of the application comprising the computer executable instructions; execute the first version of the application; store the first version of the application and related performance metrics in a memory; create at least one modified version of the application by making changes to the computer executable instructions; execute the modified version of the application; and store the modified version of the application and related performance metrics in the memory.

The computer-executable instructions when executed cause at least one data processing system to: compare the performance of the modified version of the application to the performance of the first version of the application by comparing their respective performance metrics; and determine if the performance of the modified version of the application is superior or inferior to the performance of the first version of the application.

Those skilled in the art will recognize that, for simplicity and clarity, the full structure and operation of all systems suitable for use with the present disclosure is not being depicted or described herein. Instead, only so much of a system as is unique to the present disclosure or necessary for an understanding of the present disclosure is depicted and described. The remainder of the construction and operation of the disclosed systems may conform to any of the various current implementations and practices known in the art.

Of course, those of skill in the art will recognize that, unless specifically indicated or required by the sequence of operations, certain steps in the processes described above may be omitted, performed concurrently or sequentially, or performed in a different order. Further, no component, element, or process should be considered essential to any specific claimed embodiment, and each of the components, elements, or processes can be combined in still other embodiments.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Those skilled in the art to which this application relates will appreciate that other and further additions, deletions, substitutions and modifications may be made to the described embodiments.

What is claimed is:

1. A method for maintenance and control of multiple versions of an application, comprising:
creating a first version of the application comprising computer executable instructions;
executing the first version of the application;
storing the first version of the application and related performance metrics in a memory;
creating at least one modified version of the application by making changes to the computer executable instructions;
executing the modified version of the application;
storing the modified version of the application and related performance metrics in the memory;
comparing the performance of the modified version of the application to the performance of the first version of the application by comparing their respective performance metrics; and
determining if the performance of the modified version of the application is superior or inferior to the performance of the first version of the application.

2. The method of claim 1, further comprising deleting the first version of the application from the memory if the performance of the modified version of the application is superior to the performance of the first version of the application.

3. The method of claim 1, further comprising deleting the modified version of the application from the memory if the performance of the modified version of the application is inferior to the performance of the first version of the application.

4. The method of claim 1, further comprising creating a plurality of modified versions of the application by making changes to the computer executable instructions;
executing the modified versions of the application;
storing the modified versions of the application and respective performance metrics in the memory;
comparing the performance of the stored applications by comparing their respective performance metrics; and
deleting at least one stored application from the memory based on the comparison.

5. The method of claim 1 further comprising:
comparing the performance of a most recent version of the application to the performance of previous versions of the application;
determining if the performance of the most recent version of the application is superior to the performance of the previous versions of the application; and
deleting one or more versions of the application from the memory based on the determination.

6. The method of claim 4, further comprising:
determining if a maximum allowable number of versions to be saved in the memory is exceeded; and
deleting one or more lower performing versions from the memory if the maximum allowable number of versions to be saved in the memory is exceeded.

7. The method of claim 4, further comprising:
determining if a maximum allowable number of versions to be saved in the memory is exceeded; and
storing the most recent version in the memory if the maximum allowable number of versions of the application to be saved in the memory is not exceeded.

8. The method of claim 1, wherein the performance of the plurality of versions of the applications are compared by comparing respective GPU Kernel times.

9. The method of claim 1, wherein the computer executable instructions are configured to execute sequential tasks on a central processing unit (CPU) and to execute parallel processing tasks on a graphics processing unit (GPU).

10. The method of claim 1, wherein the applications are created and executed using a CUDA profiler.

11. The method of claim 4, further comprising:
determining if the performance of the most recent version of the application is equal to or greater than a threshold performance; and
storing the most recent version of the application in the memory and deleting the previous versions of the application from the memory if the performance of the most recent version of the application is equal to or greater than a threshold performance.

12. A data processing system for maintenance and control of multiple versions of an application, comprising:
at least one processor;
a memory connected to the processor,
wherein the data processing system is configured to:
create a first version of the application comprising computer executable instructions;
execute, by the processor, the first version of the application;
store the first version of the application and related performance metrics in a memory;
create at least one modified version of the application by making changes to the program code;
execute, by the processor, the modified version of the application; and
store the modified version of the application and related performance metrics in the memory.

13. The data processing system of claim 12, wherein the system is configured to:
compare, by the processor, the performance of the modified version of the application to the performance of the first version of the application by comparing their respective performance metrics; and
determine, by the processor, if the performance of the modified version of the application is superior or inferior to the performance of the first version of the application.

14. The data processing system of claim 13, wherein the system is configured to:
delete the first version of the application from the memory if the performance of the modified version of the application is superior to the performance of the first version of the application.

15. The data processing system of claim 13, wherein the system is configured to:
delete the modified version of the application from the memory if the performance of the modified version of the application is inferior to the performance of the first version of the application.

16. The data processing system of claim 13, wherein the system is configured to:
create a plurality of modified versions of the application by making changes to the computer executable instructions;
execute the modified versions of the application;
store the modified versions of the application and respective performance metrics in the memory;
compare the performance of the stored applications by comparing their respective performance metrics; and
delete at least one stored application from the memory based on the comparison.

17. The data processing system of claim 13, wherein the system is configured to:
compare the performance of a most recent version of the application to the performance of previous versions of the application;
determine if the performance of the most recent version of the application is superior to the performance of the previous versions of the application; and
delete one or more versions of the application from the memory based on the determination.

18. The data processing system of claim 13, wherein the system is configured to:
determining if a maximum allowable number of versions to be saved in the memory is exceeded; and
delete one or more lower performing versions from the memory if the maximum allowable number of versions to be saved in the memory is exceeded.

19. The data processing system of claim 13, wherein the system is configured to:
determine if a maximum allowable number of versions to be saved in the memory is exceeded; and
store the most recent version in the memory if the maximum allowable number of versions of the application to be saved in the memory is not exceeded.

20. A non-transitory computer-readable medium encoded with computer-executable instructions for maintaining and controling multiple versions of an application, wherein the computer-executable instructions when executed cause at least one data processing system to:
create a first version of the application comprising the computer executable instructions;
execute the first version of the application;
store the first version of the application and related performance metrics in a memory;
create at least one modified version of the application by making changes to the computer executable instructions;
execute the modified version of the application; and
store the modified version of the application and related performance metrics in the memory.

21. The non-transitory computer-readable medium of claim 20, wherein the computer-executable instructions when executed cause at least one data processing system to:
compare the performance of the modified version of the application to the performance of the first version of the application by comparing their respective performance metrics; and
determine if the performance of the modified version of the application is superior or inferior to the performance of the first version of the application.

22. The non-transitory computer-readable medium of claim 20, wherein the computer-executable instructions when executed cause at least one data processing system to delete the first version of the application from the memory if the performance of the modified version of the application is superior to the performance of the first version of the application.

23. The non-transitory computer-readable medium of claim 20, wherein the computer-executable instructions when executed cause at least one data processing system to delete the modified version of the application from the memory if the performance of the modified version of the application is inferior to the performance of the first version of the application.
